(19) United States
(12) Patent Application Publication
(10) Pub. No.: US 2002/0127420 A1
(43) Pub. Date: Sep. 12, 2002

(54) Two stage thermoformable fluorinated polyoxetane-polyester copolymers

(76) Inventors: Raymond J. Weinert, Macedonia, OH (US); Martin Fay, Orwrigsburg, PA (US); Guillermina C. Garcia, Copley, OH (US); James E. Robbins, Twinsburg, OH (US)

Correspondence Address: Robert F. Rywalski, Esq., OMNOVA Solutions Inc., 175 Ghent Road, Fairlawn, OH, 44333, US

(21) Appl. No.: 10/091,754

(22) Filed: Mar. 6, 2002

Related U.S. Application Data
(63) Continuation-in-part of application No. 09/698,554, filed on Oct. 27, 2000.
Application No. 09/698,554 is a continuation-in-part of application No. 09/384,464, filed on Aug. 27, 1999, now Pat. No. 6,383,651.
Application No. 09/384,464 is a continuation-in-part of application No. 09/244,711, filed on Feb. 4, 1999.
Application No. 09/244,711 is a continuation-in-part of application No. 09/035,595, filed on Mar. 5, 1998, now abandoned.

(51) Int. Cl. B32B 27/36

(52) U.S. Cl. 428/480; 427/385.5; 427/388.3

(57) ABSTRACT

A polyoxetane-polyester polymer comprising a hydroxyl terminated polyoxetane prepolymer containing repeat units derived from polymerized oxetane monomers having one or two pendant —CH₂—O—(CH₂)ₙ—Rf groups wherein Rf is partially or fully fluorinated, where the polyoxetane prepolymer is esterified with polyester forming reactants to form the polyoxetane-polyester polymer, and said polymer is mixed with a reactive lower alkyl etherified melamine-formaldehyde to form a thermoformable coating composition. The coating composition is partially cured in a first stage heating at less than about 180° F. to provide a thermoformable partially cured, tack-free, non-blocking, coating layer, followed by application to generally a contoured substrate and thermoformed to conform thereto. The contoured partially cured coating layer is then heat cured at temperatures above at least 180° F. for time sufficient to form a cured coating.

### CROSS REFERENCE

This is a continuation-in-part of prior application Ser. No. 09/698,554, filed Oct. 27, 2000 entitled CURED POLYESTER CONTAINING FLUORINATED SIDE CHAINS, which in turn is a continuation-in-part of prior application Ser. No. 09/384,464, filed Aug. 27, 1999, entitled POLYESTER WITH PARTIALLY FLUORINATED SIDE CHAINS, which in turn is a continuation-in-part of prior application Ser. No. 09/244,711, filed Feb. 4, 1999, entitled EASILY CLEANABLE POLYMER LAMINATES, which in turn is a continuation in part of prior application Ser. No. 09/035,595, filed Mar. 05, 1998, entitled EASILY CLEANABLE POLYMER LAMINATES, all four of which are herein incorporated by reference.

### FIELD OF INVENTION

This invention pertains to thermoformable coatings applied to substrates, and more particularly to typically two stage heat curable coatings applied to thermoformable substrates such as plastics. The coating is partially cured in a first stage to form a thermoformable coating layer adhered to the substrate, and heat cured in a second stage to additionally cure the coating and provide a hard surface coating on an article having a desired configuration.

More specifically, this invention relates to fluorinated polyoxetane-polyester polymers containing polyoxetane derived from polymerizing oxetane monomers having partially or fully fluorinated pendant side chains. Polyoxetane-polyester polymers have many of the desirable properties of fluorinated polymers and the ease of processability of polyesters. The desirable properties of the fluorinated oxetane polymers are due to the fluorinated side chains and the tendency of the fluorinated side chains to be disproportionately present at the air exposed surface when cured. The fluorinated polyoxetane-polyester polymers are cured with an alkyl modified melamine formaldehyde crosslinker comprising an alkyl etherified melamine formaldehyde resin.

### BACKGROUND OF INVENTION

Thermoformable sheet substrates such as PVC are used with polymeric coated surfaces comprising crosslinked polymers to provide hard glossy surfaces exhibiting considerably increased durability to the molded top surface. In the past, coating integrity and hardness were achieved with various types of crosslinked polymers to form a tough polymer network, which worked well with flat surfaces. However, highly crosslinked polymeric coatings have limited extensibility and elasticity and consequently cannot be thermoformed into contours and configurations without cracking and similar coating integrity failure, which ordinarily occur during the thermoforming process. These thermoforming processes utilize a thermoformable substrate such as poly(vinyl chloride) surface coated with a polymeric coating which thermosets while thermoforming into a desired configuration. For these kinds of applications, the thermoset films fail. Hence, it would be highly desirable to have a cured coating system for coating thermoformable sheet substrates with sufficient coating integrity and extensibility to adhere to the PVC substrate, while exhibiting sufficient flexibility to maintain coating film integrity during the subsequent thermoforming process.

Melamine crosslinked polyester coatings are commonly used in low and high pressure laminates having flat surfaces. High pressure laminates typically consist of a multi-layer paper impregnated with melamine based coatings, where the impregnated laminate is cured at relatively high temperature and pressure to produce a finished article having a hard and durable surface. For instance, U.S. Pat. No. 4,603,074 discloses a plasticized PVC polymer layer having a polymeric surface coating comprising a reactive carboxyl functional polyester crosslinked with alkylated benzoguanamine, urea or melamine formaldehyde resin. The PVC can be printed and/or embossed prior to application of the polymeric surface coating, but the cured coating lacks flexibility and is not extensible and cracks during the thermoforming process. Similarly, U.S. Pat. No. 6,033,737 teaches plasticized PVC sheet substrate having a surface coating comprising a water-based polyester crosslinked with amino resin activated by an acid catalyst.

U.S. Pat. No. 5,650,483 describes the preparation of oxetane monomers useful to form oxetane polymers with pendant fluorinated chains. The oxetane polymers in this patent are characterized as having low surface energy, high hydrophobicity, oleophobicity and a low coefficient of friction. That patent is incorporated by reference herein for teachings on how to prepare the oxetane monomers and polymers. Additional patents issued on variations of the oxetane monomers and polymers are as follows: U.S. Pat. Nos. 5,468,841; 5,654,450; 5,663,289; 5,668,250, and 5,668,251, all of which are also incorporated herein by reference.

### SUMMARY OF THE INVENTION

It now has been found that a fluorinated polyoxetane modified polyester polymer adapted to be crosslinked with an alkyl etherified melamine-formaldehyde will provide a polymeric surface coating suitable for application to a substrate such as PVC and can be cured in generally two stages comprising, a first low temperature stage to form a partially cured thermoformable polymeric layer applied to the PVC substrate, and a second higher temperature stage in conjunction with thermoforming the thermoformable layer and the PVC substrate into a desired configuration, where the applied surface coating is more fully cured and forms a hard surface coating. The two stage reactive etherified melamine-formaldehyde crosslinking component produces a thermoformable laminate of partially cured tack free thermoformable surface coating in the first stage, and a cured, hard coating in the second stage with the applied and cured laminate residing on a contoured article.

In accordance with the present invention, a thermoformable surface coating for application to a thermoformable substrate, such as a plastic sheet, and subsequent thermoforming into a desired configuration is based on a polymeric coating comprising a reactive fluorinated polyoxetane-polyester polymer adapted to be cured with an alkyl etherified melamine-formaldehyde. The alkyl etherified melamine-formaldehyde can have two different lower alkyl groups etherified with available methylol groups on the melamine formaldehyde molecule. In the first stage, low temperature drying and curing at temperatures up to about 180° F. provides a partially cured thermoformable coating adhered to the thermoformable substrate. In the second stage, the thermoformable coating is further activated at higher temperatures to cure during the high temperature curing stage and to conform the coated substrate to the desired configuration and provide a hard surface coating. The fluorinated polyoxetane-polyester polymer comprises minor amounts of hydroxy terminated polyoxetane copolymerized polyester reactants to provide a polyester containing from about 0.1% to about 10% by weight copolymerized fluorinated polyoxetane in the fluorinated polyoxetane-polyester polymer. The reactive thermoformable coating of this invention preferably comprises on a weight basis from about 10% to 80% alkyl etherified melamine formaldehyde with the balance 20% to 90% being fluorinated polyoxetane-polyester polymer on a total resin weight basis.

### DETAILED DESCRIPTION OF THE INVENTION

The thermoformable coating composition of this invention comprises an alkyl etherified melamine formaldehyde crosslinking agent and a reactive fluorinated polyoxetane-polyester polymer which when partially cured forms a thermoformable coating layer which can be thermoformed. The polyoxetane-polyester is generally a block copolymer, and the curing generally occurs in two stages.

In accordance with this invention, modified amino resins comprising a lower alkyl etherified melamine-formaldehyde resin are utilized as crosslinking resins for the fluorinated polyoxetane-polyester polymer. The etherified melamine-formaldehyde resin is generally etherified with one or more alkyl groups derived from an alkyl alcohol set forth hereinbelow. Preferred alkyl etherified melamine-formaldehyde resins comprise mixed alkyl groups in the same melamine-formaldehyde molecule. Mixed alkyl groups comprise at least two different alkyl groups, for example, methyl and butyl. Useful alkyl groups comprise lower alkyl chains of 1 to about 6 carbon atoms where 1 to about 4 carbon atoms are preferred. Preferred mixed alkyl groups comprise at least two alkyl chains having a differential of at least two carbon atoms such as methyl/propyl, and preferably a three carbon atom differential such as methyl/butyl.

Melamine-formaldehyde molecules ordinarily comprise a melamine molecule alkylated with at least three formaldehyde molecules and more typically alkylated with four or five formaldehyde groups, while most typically fully alkylated with six formaldehyde groups to yield methanol groups, e.g. hexamethylolmelamine. In accordance with this invention, at least two, desirably three or four, and preferably five or six of the methanol groups are etherified. A melamine-formaldehyde molecule can contain mixed alkyl chains etherified along with one or more non-etherified methanol groups (known as methylol groups), although fully etherified groups are preferred to provide essentially six etherified alkyl groups. Some of the melamine-formaldehyde molecules in a melamine-formaldehyde can be non-alkylated with formaldehyde (i.e. iminom radicals), but preferably minimal to avoid undesirable rapid premature curing and to maintain controlled two stage crosslinking in accordance with this invention.

Mixed alkyl etherified melamine-formaldehyde crosslinking resins used in this invention can be produced in much the same way as conventional mono-alkyl etherified melamine-formaldehyde is produced where subsequently all or most methylol groups are etherified, such as in hexamethyoxymethylmelamine (HMMM). A mixed alkyl etherified melamine-formaldehyde can be produced by step-wise addition of two different lower alkyl alcohols or by simultaneous coetherification of both alcohols, with step-wise etherification being preferred. Typically lesser equivalents of the first etherified alcohol relative to the available methylol equivalents of melamine-formaldehyde are utilized in the first step to assure deficient reaction of alkyl alcohol with available formaldehyde groups, while excess equivalents of the second alcohol are reacted relative to remaining equivalents of formaldehyde in the second step to enable full or nearly full etherification with both alcohols. In either or both alcohol etherification steps, reaction water can be removed by distillation, or by vacuum if necessary, to assure the extent of coetherification desired. A preferred commercial mixed alkyl etherified melamine formaldehyde is Resimene CE-7103, sold by Solutia comprising mixed methyl and butyl alcohol etherified with melamine formaldehyde. The preferred mixed alkyl etherified melamine-formaldehyde exhibits temperature sensitive curing where reactivity is in two stages to provide a partially cured thermoformable laminate which can be more fully or fully cured at higher temperatures to provide hard surfaces.

In accordance with this invention, the fluorinated polyoxetane-polyester polymer which generally is a block copolymer contains a preformed fluorine modified polyoxetane having terminal hydroxyl groups. Hydroxyl terminated polyoxetane prepolymers comprise polymerized repeat units of an oxetane monomer having a pendant —CH₂—O—(CH₂)ₙ—Rf group prepared from the polymerization of oxetane monomer with fluorinated side chains. These polyoxetanes can be prepared in a manner as set forth herein below, and also according to the teachings of U.S. Pat. Nos. 5,650,483; 5,668,250; 5,688,251; and 5,663,289, hereby fully incorporated by reference. The oxetane monomer desirably has the structure

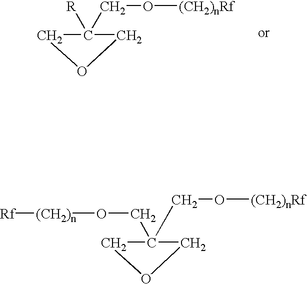

wherein n is an integer from 1 to 5, preferably from 1 to 3, and Rf, independently, on each monomer is a linear or branched, preferably saturated alkyl group of from about 1 to about 20, preferably from about 2 to about 10 carbon atoms with a minimum of 25%, 50%, 75%, 85%, or 95%, or preferably 100% perfluorinated with the H atoms of said Rf being replaced by F, R being H or an alkyl of 1 to 6 carbon atoms. The polyoxetane prepolymer can be an oligomer, a homopolymer, or a copolymer.

The repeating units from said oxetane monomers desirably have the structure

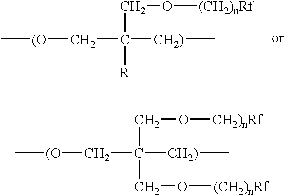

where n, Rf, and R are as described above. The degree of polymerization of the fluorinated oxetane can be from 6 to 100, advantageously from 10 to 50, and preferably 15 to 25 to produce a partially fluorinated polyoxetane prepolymer.

The hydroxyl terminated polyoxetane prepolymer comprising repeat units of copolymerized oxetane monomers ordinarily have two terminal hydroxyl groups. Useful polyoxetanes desirably have number average molecular weights from about 100, 250, 500, 1,000 or 5,000 to about 50,000 or 100,000, and can be a homopolymer or a copolymer of two or more different oxetane monomers. The polyoxetane prepolymer may be a copolymer including very minor amounts of non-fluorinated cyclic ether molecules having from 2 to 4 carbon atoms in the ring such as tetrahydrofuran and one or more oxetane monomers as described in the previously incorporated U.S. Pat. No. 5,668,250. Such a copolymer may also include very minor amounts of copolymerizable substituted cyclic ethers such as substituted tetrahydrofuran. The repeat unit from a tetrahydrofuran monomer has the formula —(O—CH₂—CH₂—CH₂—CH₂—). In some embodiments, the hydroxyl terminated polyoxetane prepolymer can include from 0% or 0.1% to 10%, advantageously 1% to 5%, and preferably 2% to 3% copolymerized THF based on the weight of the preformed hydroxyl terminated polyoxetane copolymer. The preferred polyoxetane prepolymer contains two terminal hydroxyl groups to be chemically reacted and bound into the polyoxetane-polyester polymer.

The fluorinated polyoxetane-polyester polymers are made by a condensation polymerization reaction, usually with heat in the presence of a catalyst, of the preformed fluorinated polyoxetane with a mixture of at least one dicarboxylic acid or anhydride and a dihydric alcohol. The resulting fluorinated polyoxetane-polyester polymer is a statistical polymer and may contain active hydrogen atoms, e.g., terminal carboxylic acid groups and/or hydroxyl groups for reaction with the alkyl etherified melamine-formaldehyde crosslinking resin. The ester forming reaction temperatures generally range from about 110° C. to about 275° C., and desirably from about 215° C. to about 250° C. in the presence of suitable catalysts such as 0.1% dibutyl tin oxide. Preferred carboxylic acid reactants are dicarboxylic acids and anhydrides. Examples of useful dicarboxylic acids include adipic acid, azelaic acid, sebacic acid, cyclohexane dioic acid, succinic acid, terephthalic acid, isophthalic acid, phthalic anhydride and acid, and similar aliphatic and aromatic dicarboxylic acids. A preferred aliphatic dicarboxylic acid is adipic acid and a preferred dicarboxylic aromatic acid is isophthalic acid. Generally, the aliphatic carboxylic acids have from about 3 to about 10 carbon atoms, while aromatic carboxylic acids generally have from about 8 or 10 to about 25 or 30 carbon atoms.

Useful polyhydric alcohols generally have from about 2 to about 20 carbon atoms and 2 or more hydroxyl groups, where diols are preferred. Examples of useful polyols, especially diols, include ethylene glycol, propylene glycol, diethylene glycol, dipropylene glycol, glycerin, butylene glycol, higher alkyl glycols such as neopentyl glycol, 2,2-dimethyl-1,3-propanediol, and polyols such as trimethylol propane, 1,4-cyclohexanedimethanol, glycerol pentaerythritol, trimethylolethane. Mixtures of the polyols and polycarboxylic acids can be used where diols and dicarboxylic acids dominate and higher functionality polyols and polyacids are minimized. An example of a preferred reactive polyester is the condensation product of trimethylol propane, 2,2-dimethyl-1,3-propanediol, 1,4-cyclohexanedimethanol, isophthalic acid or phthalic anhydride, and adipic acid.

The fluorinated polyoxetane-polyester polymer is made by a condensation polymerization reaction in the presence of heat and usually a catalyst with the above noted dicarboxylic acids or anhydrides and the above noted diols. The polyester component of the present invention can be formed by reacting the ester forming reactants in the presence of a preformed intermediate fluorinated polyoxetane oligomer, polymer, or copolymer to provide an ester linkage derived from esterifying a dicarboxylic acid or anhydride with the preformed polyoxetane. Alternatively, a preformed polyester intermediate can be formed from diols and dicarboxylic acids, which is then reacted with the preformed fluorinated polyoxetane oligomer, polymer, or copolymer to form the ester linkage between the respective preformed components. Thus, block copolymers are generally formed.

In preparing the hydroxyl or carboxyl functional polyoxetane-polyester polymer, it is preferred to pre-react, the hydroxyl terminated fluorinated polyoxetane oligomer, polymer, or copolymer, (polyoxetane prepolymer) with dicarboxylic acid or anhydride to assure copolymerizing the fluorinated polyoxetane prepolymer into the polyoxetane-polyester polymer via an ester linkage, which increases the percentage of fluorinated polyoxetane prepolymer incorporated into the polyoxetane-polyester polymer. A preferred process to form the ester linkage comprises reacting the hydroxyl terminated fluorinated polyoxetane prepolymer with excess equivalents of carboxylic acid from a linear dicarboxylic acid having from 3 to 10 or 30 carbon atoms such as malonic acid, or succinic acid, or glutaric acid, or adipic acid, or pimelic acid, or maleic acid, or fumaric acid, or cyclic cyclohexane dioic acid, under conditions effective to form a polyoxetane ester intermediate from the hydroxyl groups of the polyoxetane prepolymer and the carboxylic acid group of the dicarboxylic acid or anhydride. More desirably, the excess of carboxylic acid groups is at least 2.05 or 2.1 equivalents reacted with one equivalent of hydroxy terminated polyoxetane prepolymer to provide a predominantly carboxyl terminated intermediate prepolymer. The reaction temperature is generally from about 110° C. to about 275° C. and desirably from about 215° C. to about 250° C. In the preferred embodiment for producing the ester intermediate prepolymer, the amount of other diols are small or zero to force the carboxylic acid groups to react with the hydroxyl groups of the fluorinated polyoxetane prepolymer. Desirably, the equivalents of hydroxyls from other diols are less than 0.5, more desirably less than 0.2 and preferably less than 0.1 per equivalent of hydroxyls from the fluorinated polyoxetane prepolymer until after at least 70%, 80%, 90%, or 95% of the hydroxyl groups of the polyoxetane prepolymer are converted to ester links by reaction with the dicarboxylic acid.

The preferred carboxylic acid functional polyoxetane intermediate can then be reacted with other diol and dicarboxylic acid reactants to form the polyoxetane-polyester polymer. Although excess hydroxyl or carboxyl equivalents can be utilized to produce either hydroxyl or carboxyl functional polyoxetane-polyester polymer useful in this invention, preferably excess hydroxyl equivalents are copolymerized to provide a hydroxyl terminated polyoxetane-polyester polymer. Polyoxetane repeating units are usually disproportionately present at the surface of the coating due to the low surface tension of those polymerized units. The amount of surface fluorine groups can be determined by XPS (x-ray photoelectron spectroscopy).

While not as desirable, an alternative route of reacting the hydroxyl terminated fluorinated polyoxetane oligomer, polymer, or copolymer (polyoxetane prepolymer) can be reacted directly with a preformed polyester. In this procedure, the various polyester forming diols and dicarboxylic acids are first reacted to form a polyester block which is then reacted with a polyoxetane prepolymer.

The amount of fluorinated polyoxetane copolymerized in the polyoxetane-polyester polymer is desirably from about 0.1% to about 10%, advantageously from about 0.5% to about 5%, and preferably from 0.5% to about 2% or about 3% by weight based on the weight of the fluorinated polyoxetane-polyester polymer. If the hydroxyl terminated polyoxetane prepolymer includes a significant amount of copolymerized comonomer repeat units from tetrahydrofuran or other cyclic ether, the hydroxyl terminated polyoxetane prepolymer weight can exceed the level of copolymerized oxetane repeating units noted immediately above by the amount of other copolymerized cyclic ether other than oxetane used to form the polyoxetane copolymer.

The amount of the various components in the coating will be generally specified in relationship to 100% by weight of resin solids of the polyoxetane-polyester polymer and the alkyl etherified melamine-formaldehyde. The weight percent of alkyl etherified melamine formaldehyde crosslinking agent in the coating is at least 10%, desirably from about 10% to about 80%, preferably from about 20% to about 70% and most preferably from about 40% to about 60% by weight of the resin binder solids of the coating composition of this invention, with the balance being fluorinated polyoxetane-polyester polymer.

The etherified melamine formaldehyde of this invention can be used with a strong catalyst such as para-toluene sulfonic acid (PTSA) or methyl sulfonic acid (MSA). Useful acid catalysts can include boric acid, phosphoric acid, sulfate acid, hypochlorides, oxalic acid and ammonium salts thereof, sodium or barium ethyl sulfates, sulfonic acids, and similar acid catalysts. Other preferred useful catalysts include dodecyl benzene sulfonic acid (DDBSA), amine blocked alkane sulfonic acid (MCAT 12195), amine blocked dodecyl para-toluene sulfonic acid (BYK 460), and amine blocked dodecyl benezene sulfonic acid (Nacure 5543). Ordinarily from about 1% to about 15% and preferably about 3% to about 10% acid catalyst is utilized based on polyalkyletherified melamine formaldehyde used.

The amount of catalyst used is an amount that effectively catalyzes the mutual partial curing of the polyoxetane-polyester polymer and alkyl etherified melamine formaldehyde resin in the first stage as well as second stage curing under conditions chosen at elevated curing temperatures. In accordance with this invention, the first stage curing temperature is between about 120° F. and 180° F., while the second stage curing temperature is above 180° F. and preferably between about 190° F. and about 300° F.

The amount of carriers and/or solvent(s) in the coating composition can vary widely depending on the coating viscosity desired for application purposes, and solubility of the components in the solvent. The solvent(s) can be any conventional solvent for polyoxetane-polyester and melamine-formaldehyde crosslinker resin systems. These carriers and/or solvents include ketones of from 3 to 15 carbon atoms e.g. methyl ethyl ketone or methyl isobutyl ketone, alkylene glycols and/or alkylene glycol alkyl ethers having from 3 to 20 carbon atoms, acetates and their derivatives, ethylene carbonate, etc. Suitable alcohol solvents include C₁ to C₈ monoalcohols such as methyl, ethyl, propyl, butyl alcohols, as well as cyclic alcohols such as cyclohexanol. Illustrative U.S. patents of the carrier and/or solvent systems available include U.S. Pat. Nos. 4,603,074; 4,478,907; 4,888,381 and 5,374,691, which are hereby incorporated by reference for their teachings both of carriers and/or solvent systems for polyesters. Most acetate type solvents can be used, e.g. n-butyl acetate, where a preferred solvent is n-propyl acetate. The amount of solvent(s) can desirably vary from about 20 parts by weight to about 400 parts by weight per 100 parts by weight of total polyoxetane-polyester blocks and the etherified melamine-formaldehyde crosslinker resin solids.

Conventional flattening agents can be used in the coating composition in conventional amounts to control the gloss of the coating surface to an acceptable value. Examples of conventional flattening agents include the various waxes, silicas, aluminum oxide, alpha silica carbide, etc. Amounts desirably vary from about 0 or about 0.1 to about 5 or about 10 parts by weight per 100 parts by weight total of resin solids of polyoxetane-polyester polymer and etherified melamine formaldehyde.

Additionally other conventional additives can be formulated into the coating composition for particular applications. Examples include viscosity modifiers, antioxidants, antiozonants, processing aids, pigments, fillers, ultraviolet light absorbers, adhesion promoters, emulsifiers, dispersants, solvents, crosslinking agents, etc.

Intermediate coating(s) known as decorative coatings to provide a monochromatic or multicolored background or a printed (patterned) background can be likewise produced in accordance with this invention. Decorative coatings include designs, flowers, figures, graphs, maps, etc.

The thermoformable coatings of this invention can be applied to thermoformable substrates such as plastics. Examples of useful substrates that can be coated with coating compositions derived from this invention include cellulosic products (coated and uncoated paper), fibers and synthetic polymers including such as PVC preferably, or thermoplastic polyester, polyolefins, alpha olefin polymers and copolymers, polyvinyl acetate, and poly(meth)acrylates and similar thermoformable flexible or semi-rigid or rigid substrates. The substrate can be with or without a backing, with or without printing or embossment or decoration.

The thermoformed coated plastic such as PVC also can be applied to a preformed contoured solid structure or article, such as wood, to form a laminated article of a high draw or contoured article. Useful articles for example can be contoured cabinet doors, decorative formed peripheral edges on flat table tops, and similar contoured furniture configurations, as well as table tops and side panels, desks, chairs, counter tops, furniture drawers, hand rails, moldings, window frames, door panels, and electronic cabinets such as media centers, speakers, and similar contoured configurations.

The cured applied coatings retain film integrity characteristics free of undesirable cracking while exhibiting improved extensibility during the thermoforming step and having significantly improved durability, chemical resistance, stain resistance, scratch resistance, water stain resistance, and similar mar resistance characteristics, as well as good surface gloss control on the fully laminated product.

The thermoformable substrate film or layer, supported or unsupported, printed or unprinted, or decorated, single or multiple colored, can be smooth or embossed to texture the vinyl chloride layer to provide a pattern or design for esthetic or functional purposes. Embossing of thermoplastic films, layers or sheets is well known and is usually carried out by passing the film between an embossing roll and a backup roll under controlled preheating and post-cooling conditions.

In accordance with this invention, controlled generally two stage temperature dependent curing depends on the softening point of the thermoformable substrate. In particular, a wet coating is applied to a substrate (e.g. plastic) and dried to form a composite of dried coating on the substrate. The composite is then partially cured at low temperatures to form a thermoformable laminate of partially cured coating adhered to the substrate. First stage partial curing temperatures are at web temperatures below 180° F., desirably between about 120° F. and about 170° F., and preferably between about 150° F. and about 160° F., to form the laminate of partially cured thermoformable coating adhered to the substrate. Dwell time is broadly between about 2 seconds and about 60 seconds, preferably between about 10 seconds and about 20 seconds, depending on the partial curing temperature. The first stage low temperature partial curing provides a thermoformable polymeric coating while avoiding thermosetting crosslinking to form the thermoformable laminate, which can be thermoformed into any desired contour or shape. The intermediate thermoformable coating is advantageously extensible and should exhibit at least about 150% elongation at 180° F. after the first stage partial curing step. Generally, partial curing is about 70% to about 80% of the full cure of a fully cured coating. The resulting thermoformable laminate is tack free, avoids blocking or inter surface adhesion between adjacent layers when rolled or stacked in sheets, and further avoids deformation due to accumulated weight due to rolling or stacking.

In the second stage, the thermoformable laminate can then be applied to an article or structural form with established contours, draws, or configurations and fully cured at high temperatures above 181° F., and preferably from about 190° F. to about 300° F. web temperature, to provide a hard, fully cured, crack-free, mar resistant coating. Dwell time is broadly between about 30 seconds and about five minutes depending on the curing temperature. The contoured structural form, as noted above, can be a solid substrate, such as an unfinished contoured desktop, where the thermoformable laminate is contoured, thermoset, and adhered directly to the contoured solid article. Alternatively, the form can be a mold for forming a free standing thermoset contoured laminate adapted to be adhered subsequently to an unfinished contoured article. The fully cured surface exhibits considerable mar resistance along with other cured film integrity properties. Cured or fully cured coatings exhibit MEK resistance of at least about 50 MEK rubs and preferably above about 100 MEK rubs. It is readily seen that two stage step-wise heating can be achieved in two or more multiple heat curing steps to provide partial curing and full curing in accordance with this invention.

The following examples will serve to illustrate the present invention in respect to Preparation of Mono and Bis(Fluorooxetane) Monomers. Various fluorinated oxetane monomers can be made in accordance with U.S. Pat. Nos. 5,650,483; 5,668,250; 5,668,251; and 5,663,289; which have been fully incorporated by reference. While the following representative examples relate to the preparation of specific FOX (fluorooxetane) monomers, other mono or bis FOX monomers can be prepared in a very similar manner.

### EXAMPLE M1

### Preparation of 3-FOX Monomer 3-(2,2,2-Trifluoroethoxymethyl)-3-Methyloxetane

Synthesis of the 3-FOX oxetane monomer is performed as follows:

A dispersion of 50 weight percent (2.8 grams, 58.3 mmol) sodium hydride in mineral oil, was washed twice with hexanes and suspended in 35 milliliters of dimethylformamide. Then, 5.2 grams (52 mmol) of trifluoroethanol was added and the mixture was stirred for 45 minutes. A solution of 10.0 grams (39 mmol) of 3-hydroxymethyl-3-methyloxetane p-toluenesulfonate in 15 milliliters of dimethylformamide was added and the mixture was heated at 75° C.-85° C. for 20 hours, when ¹H MNR analysis of an aliquot sample showed that the starting sulfonate had been consumed.

The mixture was poured into 100 milliliters of ice water and extracted with 2 volumes of methylene chloride. The combined organic extracts were washed twice with water, twice with 2 weight percent aqueous hydrochloric acid, brine, dried over magnesium sulfate, and evaporated to give 6.5 grams of 3-(2,2,2-trifluoroethoxymethyl)-3-methyloxetane as an oil containing less than 1 weight percent dimethyl formamide. The yield of this product was 90%. The oil was distilled at 30° C. and 0.2 millimeters mercury pressure to give 4.3 grams of analytically pure 3-FOX, corresponding to a 60% yield. The analyses of the product were as follows: IR (KBr) 2960-2880, 1360-1080, 990, 840 cm⁻¹; ¹H NMR δ1.33 (s, 3H), 3.65 (s, 2H), 3.86 (q, J=8.8 Hz, 2 H), 4.35 (d, J=5.6 Hz, 2 H), 4.51 (d, J=5.6 Hz, 2 H); ¹³C NMR δ20.72, 39.74, 68.38 (q, J=40 Hz), 77.63, 79.41, 124 (q, J=272 Hz). The calculated elemental analysis for C₇ H₁₁F₃O₂ is: C=45.65; H=6.02; F=30.95. The experimental analysis found: C=45.28; H=5.83; F=30.59.

### EXAMPLE M2

Preparation of 5-FOX Monomer:

| | | Ratio | Weight | | | Mole | |
|---|---|---|---|---|---|---|---|
| Material | Scale | Weight | (S × Ratio) | MW | Mmoles | Ratio | Density |
| pentafluoropropanol | 100 | 1.00 | 100.00 | 150.05 | 666.44 | 1.00 | 1.373 |
| BrMMO | | 1.112 | 112.18 | 165.02 | 679.77 | 1.02 | 1.435 |
| TBAB | | 0.0537 | 5.37 | 322.37 | 16.66 | 0.025 | 1 |
| Water | | 0.385 | 38.53 | 18.01 | 2139.27 | 3.21 | 1.000 |
| 45% aq. KOH | | 0.914 | 91.39 | 56.10 | 733.08 | 1.10 | 1.180 |
| Water | | 0.616 | 61.57 | 18.01 | 3418.84 | 5.13 | 1.000 |
| 45% aq. KOH | | 0.027 | 2.66 | 56.01 | 21.33 | 0.032 | 1.180 |
| Water | | 0.588 | 58.81 | 18.01 | 3265.56 | 4.90 | 1.000 |
| Theoretical Yield (g) | 156.1 | | | | | | |
| Expected Yield, low (g) | 117.0 | | | | | | |
| Expected Yield, high (g) | 148.2 | | | | | | |
| Solids Loading, % | 44.9 | | | | | | |

Pentafluoropropanol, BrMMO, Tetrabutyl Ammonium bromide, and water were added to a 500 ml round bottomed flask equipped with a magnetic stirrer, thermometer, and addition funnel. The reactor was heated to 85° C., and 45% aqueous potassium hydroxide was added over 1 hour. The reactor was allowed to stir for an additional 4 hours. A 2-phase reaction mixture with a light yellow organic phase resulted. The reaction mixture was poured into a separatory funnel where the aqueous phase was removed. The organic layer was separated and washed with 45% potassium hydroxide, and deionized water. 152.31 grams of light yellow crude 5-FOX monomer was isolated. 15.40 grams of hexane was added, and the mixture was distilled. Low boilers distilled at 55° C.-60° C. at atmospheric pressure. The mixture was slowly subjected to vacuum, and additional low boilers were collected below 70° C. The vacuum was slowly increased, and 5-FOX monomer distilled from 96° C.-102° C. The vacuum was 28 inches of mercury. 133.85 grams of pure 5-FOX monomer was isolated, or 85%. Both ¹H and ¹³C spectra are consistent with 5-FOX monomer C₈H₁₁F₅O₂ molecular weight=234.16.

### EXAMPLE M3

### Preparation of 7-FOX Using PTC Process 3-(2,2,3,3,4,4,4-Heptafluorobutoxymethyl)-3-Methyloxetane

A 2 L, 3 necked round bottom flask fitted with a reflux condenser, a mechanical stirrer, a digital thermometer and an addition funnel was charged with 3-bromomethyl-3-methyloxetane (351.5 g, 2.13 mol), heptafluorobutan-1-ol (426.7 g, 2.13 mol), tetrabutylammonium bromide (34.4 g) and water (85 ml). The mixture was stirred and heated to 75° C. Next, a solution of potassium hydroxide (158 g, 87% pure, 2.45 mol) in water (200 ml) was added and the mixture was stirred vigorously at 80-85° C. for 4 hours. The progress of the reaction was monitored by GLC and when GLC analysis revealed that the starting materials were consumed, the heat was removed and the mixture was cooled to room temperature. The reaction mixture was diluted with water and the organic layer was separated and washed with water, dried and filtered to give 566 g (94%) of crude product. The crude product was transferred to a distillation flask fitted with a 6 inch column and distilled as follows:

Fraction #1, boiling between 20° C.-23° C./10 mm-Hg, was found to be a mixture of heptafluorobutanol and other low boiling impurities, was discarded;

Fraction #2, boiling between 23° C. and 75° C./1 mm-Hg, was found to be a mixture of heptafluorobutanol and 7-FOX, was also discarded; and

Fraction #3, boiling at 75° C./1 mm-Hg was >99% pure 7-FOX representing an overall yield of 80.2%

NMR and GLC data revealed that 7-FOX produced by this method was identical to 7-FOX prepared using the sodium hydride/DMF process.

### EXAMPLE M4

### Preparation of 3,3-bis(2,2,2-trifluroethoxymethyl)oxetane(B3-FOX)

Sodium hydride (50% dispersion in mineral oil, 18.4 g, 0.383 mol) was washed with hexanes (2×) and was suspended in DMF (200 mL). Then trifluoroethanol (38.3 g, 0.383 mol) was added dropwise over 45 min while hydrogen gas was evolved. The mixture was stirred for 30 min and a solution of 3,3-bis-(hydroxymethyl)oxetane di-p-toluenesulfonate (30.0 g, 0.073 mol) in DMF (50 mL) was added. The mixture was heated to 75° C. for 64 h when ¹H NMR analysis of an aliquot showed that the starting sulfonate had been consumed. The mixture was poured into water and extracted with methylene chloride (2×). The combined organic extracts were washed with brine, 2% aqueous HCl, water, dried (MgSO4), and evaporated to give 17.5 g (100%) of 3,3-bis-(2,2,2-trifluoroethoxymethyl)oxetane as an oil containing DMF (<1%). The oil was purified by bulb-to-bulb distillation at 42° C.-48° C. (10.1 mm) to give 15.6 g (79%) of analytically pure B3-FOX, colorless oil: IR (KBr) 2960-2880, 1360-1080, 995, 840 cm⁻¹; ¹H NMR δ3.87 (s 4H), 3.87 (q,J=8.8 Hz, 4H), 4,46 (s, 4H); ¹³C NMR δ43.69, 68.62 (q,J=35 Hz), 73.15, 75.59, 123.87 (q,J=275 Hz); ¹⁹F NMR δ−74.6(s). Anal. Calcd, for C₉H₁₂F₆O₃; C,38.31;H, 4.29; F, 40.40. Found: C, 38.30; H, 4.30; F, 40.19.

Preparation of oligomers, polymers or copolymers from the fluorinated oxetane monomers described herein can be made in accordance with U.S. Pat. Nos. 5,650,483; 5,668,250; 5,668251; or 5,663,289; hereby fully incorporated by reference.

The following examples demonstrate the merits of this invention.

### EXAMPLE 1

An Example of Preparing a Poly-FOX-THF Copolymer is as Follows

A 10 L jacketed reaction vessel with a condenser, thermo-couple probe, and a mechanical stirrer was charged with anhydrous methylene chloride (2.8 L), and 1,4-butanediol (101.5 g, 1.13 moles). BF₃THF (47.96 g, 0.343 moles) was then added, and the mixture was stirred for 10 minutes. A solution of 3-Fox, 3-(2,2,2-trifluoroethoxyl-methyl)-3-methyloxetane, made in accordance with U.S. Pat. Nos. 5,650,483; 5,668,250; 5,663,289; or 5,668,251, (3,896 g. 21.17 moles) in anhydrous methylene chloride (1.5 L) was then pumped into the vessel over 5 hours. The reaction temperature was maintained between 38° C. and 42 ° C. throughout the addition. The mixture was then stirred at reflux for an additional 2 hours, after which ¹H NMR indicated >98% conversion. The reaction was quenched with 10% aqueous sodium bicarbonate (1 L), and the organic phase was washed with 3% aq. HCI (4 L) and with water (4 L). The organic phase was dried over sodium sulfate, filtered, and stripped of solvent under reduced pressure to give 3,646 g (91.2%) of title glycol, a clear oil. NMR: The degree of polymerization (DP) as determined by TFAA analysis was 15.2 which translates to an equivalent weight of 2804. The THF content of this glycol, as determined by 1 H NMR, was 2.5% wt THF (6.2% mole THF). This example was included to teach how to polymerize partially fluorinated oxetane polymers.

### EXAMPLE 2

Synthesis of Poly-5-FOX-THF Copolymer at a DP of 20

| | | | Weight | | | | | |
|---|---|---|---|---|---|---|---|---|
| | | | (S × Ratio) | | | Mole | | |
| Compound | Scale | Ratio | G | MW | Moles | Ratio | δ | ml |
| 5-FOX Monomer⁽¹⁾ | 979.3 | 1.0 | 979.250 | 234.16 | 4.18 | 50.05 | 1.150 | 851.5 |
| THF | | 0 | 0.000 | 72.10 | 0.00 | 0.00 | 0.886 | 0.0 |
| Methylene Chloride | | 0.53 | 519.003 | 84.93 | 6.11 | 73.14 | 1.330 | 390.2 |
| Neopentylglycol | | 0.02222 | 21.756 | 104.15 | 0.21 | 2.50 | 1.017 | 21.4 |
| BF³THF | | 0.01194 | 11.689 | 139.90 | 0.08 | 1.00 | 1.268 | 9.2 |
| Methylene Chloride | | 0.8 | 783.400 | 84.93 | 9.22 | 110.40 | 1.330 | 589.0 |
| 5% sodium bicarbonate | | 0.43 | 421.078 | 18.01 | 23.38 | 279.82 | 1.000 | 421.1 |
| Water | | 0.85 | 832.363 | 18.01 | 46.22 | 553.13 | 1.000 | 832.4 |
| Theoretical Yield (g) | 1007.03 | | | | | | | |
| Expected Yield, Low (g) | 906.33 | | | | | | | |
| Expected Yield, High (g) | 956.68 | | | | | | | |
| Solids Loading, % | 63.93 | | | | | | | |
| Max. Wt% BF₃THF | 1.16 | | | | | | | |
| (incorporated as THF) | | | | | | | | |
| | ml | | | | | | | |
| Initial Volume | 1272.36 | | | | | | | |
| Volume after quench, ml | 2282.46 | | | | | | | |
| Volume after wash, ml | 2693.75 | | | | | | | |

⁽¹⁾5-FOX Monomer is oxetane with a pendant -CH₂-O-CH₂-CF₂-CF₃and molecular weight of 234.16.

Methylene chloride (1019.003 grams, 11.99 moles, 766.1 7 ml) was charged to a 4 liter jacketed reaction vessel equipped with a reflux condenser, mechanical stirrer, temperature probe, monomer addition pump, and jacket temperature control. Neopentyl glycol (21.756 grams, 0.21 moles) and BF₃THF (11.689 grams, 0.08 moles) were charged to the reactor with a temperature of 25° C. The neopentyl glycol dissolved upon addition of BF₃THF. The reaction was allowed to stir for 30 minutes. 5-FOX monomer addition was commenced with a reaction temperature of 25° C., and a reaction exotherm was observed within 5 minutes. Once the exotherm started, 5-FOX monomer was added over 75 minutes. The maximum temperature observed was 36.3° C. After complete addition of the monomer, the reaction mixture was heated to 35° C. for 4 hours. A sample was taken and analyzed by NMR, and a degree of polymerization of 21.35 was observed. Additional methylene chloride was added (283.4 grams, 213.08 ml). The reaction mixture was neutralized with 5% sodium bicarbonate solution (421.078, 21.0539 grams sodium bicarbonate, 0.2506 moles). The methylene chloride-polymer layer was then washed with deionized water (832.363 grams). A pH of 7 was observed. The water phase was separated. The polymer phase is distilled under reduced pressure to remove methylene chloride and dry the polymer. About 963.61 grams of poly-5-FOX-THF Copolymer DP 21.35 were isolated.

### EXAMPLE 3

Synthesis of PoIy-3-FOX-co-PoIy-Elf-FOX 25%

| | | | Quantity | | | | | |
|---|---|---|---|---|---|---|---|---|
| Substance | Scale (g) | Ratio | (g) | MW | Eq | Mmoles | δ | ml |
| Elf FOX Monomer⁽¹⁾ | 3500 | 0.490577 | 1,717.02 | 532 | 5.00 | 3,227.48 | 1.4 | 1226.4 |
| 3-FOX Monomer⁽²⁾ | | 0.509425 | 1,782.99 | 184.15 | 15.00 | 9,682.26 | 1.15 | 1550.4 |
| Neopentyl Glycol | | 0.0191986 | 67.20 | 104.1 | 1.00 | 645.49 | 1.06 | 63.4 |
| Heloxy 7 | | 0.0420488 | 147.17 | 228 | 1.00 | 645.49 | 0.91 | 161.73 |
| BF₃THF | | 0.00806 | 28.21 | 139.9 | 0.31 | 201.64 | 1.1 | 25.6 |
| Oxsol 2000 | | 0.57 | 1,995.00 | 146.11 | 21.15 | 13,654.10 | 1.185 | 1683.5 |
| CH₂CI₂ | | 0.205 | 717.50 | 84.93 | 13.09 | 8,448.13 | 1.326 | 541.1 |
| Quench (water) | | | 2,576.97 | 18.01 | 221.67 | 143,085.52 | 1.00 | 2577.0 |
| Wash (water) | | | 2,576.97 | 18.01 | 221.67 | 143,085.52 | 1.00 | 2577.0 |
| Theoretical Yield (g) | 3,728.91 | | | | | | | |
| Expected Yield, | 3,542.47 | | | | | | | |
| (95%) | | | | | | | | |
| Solids Loading, (%) | 72.35% | | | | | | | |
| | ml | | | | | | | |
| Initial Volume | 5,153.94 | | | | | | | |
| Volume + Quench | 7,730.91 | | | | | | | |
| Volume + Wash | 7,730.91 | | | | | | | |

⁽¹⁾Poly Elf FOX Monomer is oxetane with mixed pendant fluorinated C₄-C₁₆alcohols from ALF Actochem
⁽²⁾3-FOX Monomer is oxetane with a pendant Rf =CF₃.

Methylene chloride (717.50 grams, 8.45 moles, 541.1 ml) was charged to a 10 liter jacketed reaction vessel equipped with a reflux condenser, mechanical stirrer, temperature probe, monomer addition pump, and jacket temperature control. Neopentyl glycol (67.20 grams, 0.645 moles) and BF₃THF (28.21 grams, 0.201 moles) were charged to the reactor with a temperature of 25° C. The neopentyl glycol dissolved upon addition of BF₃THF. The reaction was allowed to stir for 30 minutes. A solution of Elf-FOX monomer (1717.02 grams, 3.227 moles, 1226.4 ml), 3-FOX monomer (1,782.99 grams, 9.682 moles, 1550.4 ml), and Heloxy 7 (147.17 grams, 0.645 moles, 161.73 ml) in Oxsol 2000 (1995.00 grams, 1683.5 ml) was prepared. Addition of the monomer solution was commenced with a reaction temperature of 25° C., and a reaction exotherm was observed within 7 minutes. Once the exotherm started, monomer was added over 1 hour 55 minutes. The maximum temperature observed was 40.0° C. After complete addition of the monomer, the reaction mixture was heated to 35° C. for 4 hours. A sample was taken and analyzed by NMR, and a total FOX degree of polymerization of 18.67 was observed. The reaction mixture was neutralized with 5% sodium bicarbonate solution (2576.97 grams, 128.85 grams sodium bicarbonate, 1.53 moles). The methylene chloride-polymer layer was then washed with deionized water (2576 grams). A pH of 7 was observed. The water phase was separated. The polymer phase is distilled under reduced pressure to remove methylene chloride and dry the polymer. 3632.4 grams of poly-3-FOX-co-Elf-FOX 25% DP 18.67 was isolated. Final characterization showed 23.5% Elf-FOX, and a hydroxyl equivalent weight of 2640.6.

### EXAMPLE 4

Synthesis of Poly-3-FOX-Z 10 Copolymer

An oxetane copolymer was produced in the same manner as described in Example 3 except the weight ratio of monomers was 90% 3-FOX monomer and 10% Z 10 monomer produced by DuPont. Z10 monomer is an oxetane monomer with mixed pendant fluorinated alkyl alcohol chains.

### EXAMPLE 5

Synthesis of Fluorinated Polyoxetane-Polyester Polymer Blocks

Two different hydroxyl terminated fluorinated polyoxetanes were used to prepare different polyoxetane-polyester polymers according to this invention. The first polyoxetane had 6 mole percent repeating units from tetrahydrofuran (THF) with the rest of the polymer being initiator fragment and repeating units form 3-FOX where n=1, Rf is CF₃, and R is CH₃. The number average molecular weight of the first polyoxetane was 3400. The second polyoxetane had 26 mole percent of its repeating units from tetrahydrofuran with the residual being the initiator fragment and repeating units from 3-FOX. 3-FOX is also known as 3-(2,2,2-trifluoroethoxylmethyl)-3-methyloxetane.

The first and second fluorinated oxetane polymers were reacted with at least a 2 equivalent excess (generally 2.05-2.10 excess) of adipic acid in a reactor at 455° F. for 3.5 hours to form a polyoxetane having the half ester of adipic acid as carboxyl end groups. The preformed ester linkage and terminal carboxyl groups will chemical bond the polyoxetane to a subsequently in-situ formed polyester. NMR analysis was used to confirm that substantially all the hydroxyl groups on the polyoxetane were converted to the ester groups. The average degree of polymerization of the first oxetane polymer was reduced from 18 to 14 during the reaction with adipic acid. The average degree of polymerizations of the second oxetane polymer remained at 18 throughout the reaction. The reactants were then cooled to 300° F.

The adipic acid functionalized polyoxetane was then reacted with additional diacids and diols to form polyester blocks. The diacids were used in amounts of 24.2 parts by weight of adipic acid and 24.5 parts by weight of isophthalic acid or phthalate anhydride. The diols were used in amounts of 20.5 parts by weight of cyclohexanedimethanol, 14.8 parts by weight neopentyl glycol, and 16.0 parts by weight trimethylol propane. The relative amounts of the adipate ester of the oxetane polymer and the polyester forming components were adjusted to result in polyoxetane-polyesters with either 2 or 4 weight percent of partially fluorinated oxetane repeating units. The diacid and diol reactants were reacted in the same reactor used to form the carboxyl functional polyoxetane but the reaction temperature was lowered to 420° F. The reaction to form the polyoxetane-polyester polymer was continued until the calculated amount of water was generated. The finished batch sizes were from 20 to 30 gallons.

The resulting polyoxetane-polyester polymer was formulated into coating compositions according to “Coating Preparation” set forth hereinafter. The polyoxetane-polyester polymers were mixed with an alkyl etherified melamine-formaldehyde resin Resimene CE-7103, a highly monomeric, methyl/butyl etherified melamine-formaldehyde sold by Solutia.

Coating Preparation and Testing

Coating Preparation

Flurorinated polyoxetane-polyester polymer was mixed with Resimene CE-7103 methyl/butyl etherified melamine-formaldehyde crosslinking agent. The poly 5-FOX-polyester polymer is made from a poly-5-FOX polymer as made in example 2 and is reacted with adipic acid to form an ester linkage having a terminal carboxyl group and subsequently reacted with ester forming monomers in a manner substantially as set forth in Example 5 wherein the acids are adipic acid and phthalate anhydride.

| | | | |
|---|---|---|---|
| 1. | Resimene CE-7103 is a highly | 31.4 | pph |
| | monomeric, methyl/butyl etherified | | |
| | melamine-formaldehyde resin. | | |
| | (Solutia, Resimene CE-7103) | | |
| 2. | Poly-5-FOX-Polyester Polymer | 31.4 | pph |
| 3. | N-propyl acetate | 20.7 | pph |
| 4. | Tetrahydrofuran | 3.5 | pph |
| 5. | Isopropyl alcohol | 6.0 | pph |
| 6. | Para-toluene sulfonic acid | 4.0 | pph |
| 7. | Polyether modified | 0.7 | pph |
| | dimethylpolysiloxane copolymer | | |
| | (Byk-Chemie BYK-333) | | |
| 8. | Fumed silica (Degussa TS100) | 1.4 | pph |
| 9. | Micronized fluorocarbon wax | 0.9 | pph |
| | (Micropowders Polyfluo 190) | | |

The polyether modified dimethylpolysiloxane copolymer (BYK 333) was added to improve scratch and mar resistance.

The fumed silica (Degussa TS100) was added to control the coating gloss.

The micronized fluorocarbon wax was added to improve scratch and mar resistance.

Sample Preparation

Coatings were applied to PVC sheets with a gravure coater and dried in a forced air oven and then partially cured at 150° F. to 160° F. for 10 to 20 seconds to form a partially cured thermoformable coating film. Coating weights were 6-8 grams/square meter of substrate. The PVC substrate was 0.012 inch thick with a lightly embossed surface (E13 embossing).

Thermoforming and Curing Procedure

The coated samples were thermoformed to MDF wood board using a Greco membrane press. The press cycle is described below.

1. Coated PVC is placed over a MDF board

2. Flexible membrane is laid over PVC film and MDF board

3. The membrane is heated to 280° F. to thermoform and cure

4. A vacuum pulls the membrane tightly around PVC film and MDF board (thermoforming). Heat is maintained for 1 minute

5. Heat is removed and membrane is allowed to cool for 1 minute while vacuum is maintained

6. After 1 minute cooling, vacuum is released and sample is removed

7. Maximum surface temperature of PVC is measured and recorded with a temperature indicating tape.

The following test procedures were used to measure coating durability (resistance to coating cracking).

Scratch Resistance

Scratch resistance was measured with a “Balance Beam Scrape Adhesion and Mar Tester” that is manufactured by the Paul N. Gardner Company, Inc. A. Hoffman stylus was used to scratch the coatings. The scratch resistance is the high stylus load the coating can withstand without scratching.

Burnish Mar

Mar resistance was determined by firmly rubbing a polished porcelain pestle on the coating surface. The severity of a mark is visually assessed as:

| | |
|---|---|
| Severe: | mark is visible at all angles |
| Moderate: | mark is visible at some angles |
| Slight: | mark is visible only at grazing angles |
| None: | no perceivable mark |

Solvent Resistance (MEK Double Rubs)

A cloth towel was soaked with MEK and gently rubbed on the coated surface in a back and forth manner. One back and forth movement was counted as one rub. The coated surface was rubbed until a break in the coating surface first became visible. The test is stopped after 100 double-rubs.

Coating Crack

After thermoforming the coated PVC films to molded MDF parts, the corners and edges were visually inspected for coating cracks.

Cleanability/Stain

Stain resistance was measured by common household substances published by NEMA Standards Publications LD-3 for High Pressure Decorative Laminates. The method consists of placing a spot of each test reagent i.e. distilled water, acetone, household ammonia, critic acid solution, olive oil, tea, coffee, mustard, providone iodine, stamp ink, #2 pencil, wax crayon, and shoe polish, upon the flat surface of the laminated PVC. The samples were undisturbed for 16 hours and after that the stain reactants were cleaned with different stain removers that are commonly used as commercial cleaners (i.e. 409, Fantastik), baking soda, nail remover, and finally bleach. Depending on the stain severity (high values) or ease (low values) of its removal, the total value from each test sample was determined.

TABLE 1
Stain Remover Values

| Cleaner - Remover | Grade |
|---|---|
| Water | 0 |
| Commercial Cleaner | 1 |
| Commercial cleaner + baking soda | 2 |
| Nail Polish Remover | 3 |
| 5.0% solution of sodium hypochlorite (bleach) | 4 |

Coated Substrate Versus Uncoated Substrate

TABLE 2
Durability Testing

| | | COATED | |
|---|---|---|---|
| | COATED + | AND | |
| | THERMOFORMED | PARTIALLY | |
| PROPERTIES | AND CURED | CURED | UNCOATED |
| Hoffman Scratch | 2050 g | 1850 g | 1000 g |
| Burnish Mar | Slight | Slight | Moderate |
| MEK double rub | 90 rubs | 60 rubs | 4 rubs |
| Coating crack | None | None | None |

TABLE 3
NEMA Stain Test Results
(Coated + Thermoformed and Cured)

| | cleaning reagents | | | | | | |
|---|---|---|---|---|---|---|---|
| Test Material | 1 | 2 | 3 | 4 | 5 | Score | Stain |
| Distilled water | | | | | | | |
| 50/50:Distilled water/Ethyl | | | | | | | |
| Alcohol | | | | | | | |
| Acetone | 1 | 1 | 1 | 1 | 1 | 5 | Moderate |
| Household Ammonia | | | | | | | |
| Citric Acid | | | | | | | |
| Vegetable cooking Oil | | | | | | | |
| Coffee | | | | | | | |
| Tea | 1 | | | | | 1 | |
| Catsup | | | | | | | |
| Mustard | 1 | 1 | 1 | | | 3 | |
| 10% Povidone Iodine | 1 | | | | | 1 | |
| Permanent Marker | 1 | 1 | 1 | | | 3 | |
| #2 Pencil | 1 | | | | | 1 | |
| Wax Crayon | 1 | | | | | 1 | |
| Shoe Polish | 1 | | | | | 1 | |
| | | | | | Total | 16 | |

Stain remover values from Table 1 were used below in a progressing intensity stain removing test scale, where
0 = water
1 = commercial cleaner
2 = commercial cleaner and baking soda
3 = Nail polish remover
4 = Solution 5% of sodium hypochlorite (bleach)
A ″1″in the test result indicates the stain was not removed until a stronger stain remover was used.

TABLE 4
NEMA Stain Results (Coated and Partially Cured)

| | Cleaning reagents | | | | | | |
|---|---|---|---|---|---|---|---|
| Test Material | 1 | 2 | 3 | 4 | 5 | Score | Stain |
| Distilled Water | | | | | | | |
| 50/50:Distilled Water/Ethyl | | | | | | | |
| Alcohol | | | | | | | |
| Acetone | 1 | 1 | 1 | 1 | 1 | 5 | Moderate |
| Household Ammonia | | | | | | | |
| Citric Acid | | | | | | | |
| Vegetable Cooking Oil | | | | | | | |
| Coffee | | | | | | | |
| Tea | 1 | | | | | 1 | |
| Catsup | | | | | | | |
| Mustard | 1 | 1 | | | | 2 | |
| 10% Povidone Iodine | | | | | | | |
| Permanent Marker | 1 | 1 | 1 | | | 3 | |
| #2 Pencil | 1 | | | | | 1 | |
| Wax Crayon | 1 | | | | | 1 | |
| Shoe Polish | 1 | | | | | 1 | |
| | | | | | Total | 14 | |

TABLE 5
NEMA Stain Results (Uncoated)

| | Cleaning reagents | | | | | | |
|---|---|---|---|---|---|---|---|
| Test Material | 1 | 2 | 3 | 4 | 5 | Score | Stain |
| Distilled Water | | | | | | | |
| 50/50:Distilled Water/Ethyl | | | | | | | |
| Alcohol | | | | | | | |
| Acetone | 1 | 1 | 1 | 1 | 1 | 5 | Moderate |
| Household Ammonia | | | | | | | |
| Citric Acid | | | | | | | |
| Vegetable Cooking Oil | | | | | | | |
| Coffee | 1 | 1 | | | | 2 | |
| Tea | | | | | | | |
| Catsup | | | | | | | |
| Mustard | | | | | | | |
| 10% Povidone Iodine | | | | | | | |
| Permanent Marker | 1 | 1 | 1 | 1 | 1 | 5 | Moderate |
| #2 Pencil | 1 | 1 | | | | 2 | |
| Wax Crayon | 1 | 1 | | | | 2 | |
| Shoe Polish | 1 | 1 | 1 | | | 3 | |
| | | | | | Total | 16 | |

Results

Coated samples showed significantly greater Hoffman scratch resistance compared to uncoated PVC. The coated+thermoformed sample showed a greater Hoffman scratch resistance compared to the coated sample.

The burnish resistance of the coated+thermoformed and coated samples were greater than the uncoated PVC.

The coated+thermoformed sample withstood 90 MEK double rubs and the coated sample withstood 60 MEK double rubs. The greater number of double rubs observed for the coated+thermoformed sample indicates a greater level of curing or postcured that occurs during the thermoforming process. After 4 double rubs, the surface of uncoated PVC began to show streaks.

The NEMA cleanability score from the thermoformed+coated and coated sample were 16 and 14, respectively. The uncoated PVC showed a cleanability score of 19. After cleaning all of the samples showed a moderate stain from acetone. In addition, the uncoated PVC showed a moderate stain from a permanent marker.

The foregoing representative examples illustrate the merits of the invention but are not intended to limit the scope of the invention except by the appended claims.

While in accordance with the patent statutes the best mode and preferred embodiment have been set forth, the scope of the invention is not intended to be limited thereto, but only by the scope of the attached claims.

What is claimed:

1. A thermoformable polyoxetane-polyester polymer coating composition, comprising:
a) a polymer of at least one polyoxetane block having repeating units derived from polymerizing at least one oxetane monomer having at least one pendant —CH₂—O—(CH₂)ₙ—Rf group, and at least one polyester block having a molecular weight above 100,
wherein a hydroxyl group of said polyoxetane block is prereacted with a dicarboxylic acid having from about 3 to about 30 carbon atoms or an anhydride thereof to form an ester linkage and a carboxylic acid terminal group, and thereafter said terminal carboxylic acid group is reacted with ester forming monomers or a preformed polyester to form the polyoxetane-polyester polymer, and said Rf group, independently, on each repeating unit, being a linear or branched alkyl group of from 1 to about 20 carbon atoms with a minimum of 25% of the hydrogen atoms of said alkyl group being replaced by F, and optionally up to all of the remaining H atoms being replaced by I, Cl, or Br; and n being from 1 to about 5, and
b) a lower alkyl etherified melamine-formaldehyde curing resin having lower alkyl groups etherified with melamine-formaldehyde.

2. The thermoformable coating composition of claim 1, wherein said etherified melamine formaldehyde comprises melamine formaldehyde etherified with at least three alkyl groups.

3. The thermoformable coating composition of claim 1, wherein the etherified melamine formaldehyde comprises a melamine-formaldehyde etherified with two or more different lower alkyl groups, and wherein the alkyl group contains from 1 to 6 carbon groups.

4. The thermoformable coating composition of claim 1, wherein said melamine formaldehyde is etherified with alkyl groups, independently, containing from 1 to 4 carbon atoms.

5. The thermoformable coating composition of claim 3, wherein the different alkyl groups differ by at least three carbon atoms.

6. The thermoformable coating composition of claim 1, wherein said composition is partially cured in a first stage at a low temperature, and wherein said partially cured composition is capable of being cured in a second stage at a higher temperature than 180° F.

7. The thermoformable coating composition according to claim 4, wherein said polyoxetane block has a DP of from about 6 to about 100, wherein n is 1 to about 3, wherein Rf, independently, has a minimum of 50% of the hydrogen atoms replaced by F; and wherein said dicarboxylic acid forming said ester linkage is oxalic acid, or malonic acid, or succinic acid, or glutaric acid, or adipic acid, or pimelic acid or, maleic acid, or fumaric acid, or cyclohexane diacid, or mixtures thereof.

8. The thermoforming coating composition of claim 7, wherein said polyoxetane block is a copolymer derived from copolymerization of said oxetane monomer and a cyclic ether comonomer having from 2 to about 4 carbon atoms in the ring, and wherein the amount of said cyclic ether comonomer is up to about 10% by weight based on the total weight of said comonomer and said oxetane monomer.

9. The thermoformable coating composition of claim 8, wherein said cyclic ether is tetrahydrofuran.

10. The thermoformable coating composition according to claim 9, wherein said amount of said alkyl etherified melamine-formaldehyde crosslinking resin is from about 20% to about 70% by weight based upon the total weight of said crosslinking resin and said polyoxetane-polyester block polymer, and wherein the amount of said polyoxetane prepolymer is from about 0.1 to about 10% by weight based upon the weight of said polyoxetane-polyester block polymer.

11. The thermoformable coating composition of claim 1, wherein the dicarboxylic acid prereacted with the polyoxetane block is adipic acid.

12. The thermoformable coating composition of claim 7, wherein the dicarboxylic acid prereacted with the polyoxetane block is adipic acid.

13. The thermoformable coating composition of claim 10, wherein the melamine formaldehyde is etherified with at least two different alkyl groups.

14. The thermoformable coating composition of claim 13, wherein said DP is from about 10 to about 50, wherein Rf is saturated alkyl and has a minimum of 75% of said H atoms replaced by F.

15. The thermoformable coating composition of claim 14, wherein the polyester block is formed from adipic acid, isophthalic acid or phthalic anhydride, or combinations thereof, and from 2,2-dimethyl-1,3-propanediol, trimethylol propane, and cyclohexane dimethanol.

16. The thermoformable coating composition of claim 7, wherein Rf is perfluorinated.

17. The thermoformable coating composition of claim 15, wherein Rf is perfluorinated.

18. A process for producing a thermoformable coating for application to a substrate comprising the steps of:
providing a preformed hydroxyl terminated polyoxetane of polymerized oxetane monomers having one or two pendant ether side chains terminated with fluorocarbon groups, wherein said pendant ether side chain has the formula —CH₂—O—(CH₂)ₙ—Rf, wherein said Rf group, independently, is a linear or branched alkyl group of from 1 to about 20 carbon atoms with a minimum of 25% of the hydrogen atoms of said alkyl group being replaced by F, and optionally up to all of the remaining H atoms being replaced by I, Cl, or Br; and n being from 1 to about 5;
esterifying the hydroxyl terminated polyoxetane with a dicarboxylic acid reactant derived from at least one dicarboxylic acid or anhydride to form an acid end group and subsequently esterifying said acid end group with ester forming monomers or a preformed polyester to form a polyoxetane-polyester polymer;
mixing the polyoxetane-polyester polymer with an alkyl etherified melamine-formaldehyde crosslinking resin,
reacting the polyoxetane-polyester polymer and said alkyl etherified melamine-formaldehyde crosslinking resin at a first temperature to form a partially cured thermoformable coating, and
curing said partially cured thermoformable coating at a temperature higher than said first temperature.

19. The process of claim 18, wherein said etherified melamine formaldehyde comprises melamine formaldehyde etherified with at least three alkyl groups.

20. The process of claim 18, wherein the etherified melamine-formaldehyde is etherified with six alkyl groups.

21. The process of claim 18, wherein the etherified melamine formaldehyde comprises a melamine-formaldehyde etherified with two or more different lower alkyl groups.

22. The process of claim 21, wherein the mixed alkyl groups have a differential of at least 3 carbon atoms.

23. A process for forming a partially cured thermoformable laminate, the laminate process steps comprising:
providing a thermoformable coating composition comprising a polyoxetane-polyester polymer of a hydroxyl functional polyoxetane prepolymer esterified with a dicarboxylic acid or anhydride to form an acid end group, and subsequently esterifying said acid end group with ester forming monomers or a preformed polyester to form the polyoxetane-polyester polymer, and reacting said polyoxetane-polyester polymer with a lower alkyl etherified melamine-formaldehyde, said polyoxetane prepolymer comprising a polyoxetane having repeat units derived from polymerizing oxetane monomers having at least one pendant —CH₂—O—(CH₂)ₙ—Rf group, with each n being, independently, 1 to 5; and each Rf being, independently, saturated or unsaturated, a linear or branched alkyl group of from 1 to about 20 carbon atoms with a minimum of 25% of the hydrogen atoms of said alkyl group being replaced by F,
mixing the polyoxetane-polyester polymer with an alkyl etherified melamine-formaldehyde crosslinking resin at a temperature of less than about 180° F. to form a partially cured thermoformable coating layer, and
applying the thermoformable coating layer to a substrate and forming a thermoformable laminate.

24. The laminate process of claim 23, wherein the coating applied to the substrate is partially cured at a temperature between about 120° F. and 180° F. to form the thermoformable coating.

25. The laminate process of claim 24, wherein said etherified melamine formaldehyde comprises melamine formaldehyde etherified with at least three alkyl groups, and wherein said alkyl group contains from 1 to 6 carbon atoms.

26. The laminate process of claim 25, wherein the partially cured thermoformable coating has an elongation extensibility of at least about 150% at 180° F.

27. The laminate process of claim 26, wherein the partially crosslinked thermoformable coating layer is capable of being cured at a temperature of from about 190° F. to about 300° F., wherein said dicarboxylic acid or anhydride etherifying said hydroxyl functional polyoxetane prepolymer is oxalic acid, or malonic acid, or succinic acid, or glutaric acid, or adipic acid, or pimelic acid or, maleic acid, or fumaric acid, or cyclohexane diacid, or mixtures thereof, wherein the polyoxetane has a DP of from about 6 to about 100, wherein n is 1 to about 3, and wherein Rf, independently, has a minimum of 50% of the hydrogen atoms replaced by F.

28. The laminate process of claims 27, wherein said polyoxetane block has a DP of from about 10 to about 50, and wherein Rf, independently, has a minimum of 75% of the hydrogen atoms replaced by F.

29. The laminate process of claim 28, wherein the polyoxetane prepolymer comprises a copolymer of said oxetane monomer and from 0.1% to 10% by weight cyclic ether having from 2 to 4 carbon atoms in the cyclic ring based on the total weight of said oxetane monomer and cyclic monomer, and wherein said amount of said alkyl etherified melamine-formaldehyde crosslinking resin is from about 10% to about 70% by weight based upon the total weight of said crosslinking resin and said polyoxetane-polyester polymer.

30. The laminate process of claim 29, wherein the cyclic monomer is tetrahydrofuran.

31. A laminate comprising:
a partially cured thermoformable coating applied to a substrate, the thermoformable coating comprising a polyoxetane-polyester polymer derived from a hydroxyl functional polyoxetane of polymerized oxetane monomers, the polyoxetane prereacted with a dicarxoylic acid or anhydride to form an ester linkage and a carboxylic acid end group, said acid end group subsequently esterified with ester forming monomers or a preformed polyester to form the polyoxetane-polyester polymer, the polyoxetane-polyester polymer being partially cured with a lower alkyl etherified melamine-formaldehyde crosslinker, wherein said oxetane monomer has a least one pendant —CH₂—O—(CH₂)ₙ—Rf group, said Rf group, independently, on each repeating unit, being a linear or branched alkyl group of from 1 to about 20 carbon atoms with a minimum of 25% of the hydrogen atoms of said alkyl group being replaced by F, and optionally up to all of the remaining H atoms being replaced by I, Cl, or Br; and n being from 1 to about 5.

32. The laminate of claim 31, wherein said etherfied melamine formaldehyde comprises melamine formaldehyde etherfied with at least three alkyl groups wherein each alkyl group, independently, contains from 1 to 6 carbon atoms.

33. The laminate of claim 32, wherein wherein said polyoxetane block has a DP of from about 6 to about 100, wherein n is 1 to about 3, wherein Rf, independently, has a minimum of 50% of the hydrogen atoms replaced by F; and wherein said dicarboxylic acid forming said ester linkage is oxalic acid, or malonic acid, or succinic acid, or glutaric acid, or adipic acid, or pimelic acid or, maleic acid, or fumaric acid, or cyclohexane diacid, or mixtures thereof.

34. The laminate of claim 33, wherein said polyoxetane block is a copolymer derived from copolymerization of said oxetane monomer and a cyclic ether comonomer having from 2 to about 4 carbon atoms in the ring, and wherein the amount of said cyclic ether comonomer is up to about 10% by weight based on the total weight of said comonomer and said oxetane monomer.

35. The laminate of claim 34, wherein said amount of said alkyl etherified melamine-formaldehyde crosslinking resin is from about 10% to about 70% by weight based upon the total weight of said crosslinking resin and said polyoxetane-polyester polymer, and wherein the amount of said polyoxetane prepolymer is from about 0.1 to about 10% by weight based upon the weight of said polyoxetane-polyester polymer.

36. The laminate of claim 31, wherein the laminate is cured and is an article of furniture.

37. The laminate of claim 35, wherein the laminate is cured and is an article of furniture.

38. The laminate of claim 31, wherein the laminate is cured and is an article of cabinetry.

39. The laminate of claim 35, wherein the laminate is cured and is an article of cabinetry.
